(19) United States
(12) Patent Application Publication
(10) Pub. No.: US 2022/0305576 A1
(43) Pub. Date: Sep. 29, 2022

(54) METHOD AND FIXTURE FOR CUTTING A WORKPIECE

(71) Applicant: Festool GmbH, Wendlingen (DE)

(72) Inventors: Christian Jacob, Goeppingen (DE); Julian Schmitt, Huenfeld (DE); Felix Kinyanjui Reiser, Stuttgart (DE); Charlotte Schleifenbaum, Rechberghausen (DE)

(73) Assignee: Festool GmbH, Wendlingen (DE)

(21) Appl. No.: 17/652,686

(22) Filed: Feb. 26, 2022

Related U.S. Application Data
(60) Provisional application No. 63/200,362, filed on Mar. 2, 2021.

(51) Int. Cl. B23D 51/02

(52) U.S. Cl. CPC B23D 51/02

(57) ABSTRACT

A fixture for cutting a workpiece using a powered tool. The present disclosure describes a fixture that may be used to cut molding to match the profile of an adjacent molding piece. The fixture includes a saw blade receiver to guide an end of a saw blade through a longitudinal movement as the saw blade is driven by a powered tool. The saw blade receiver maintains a tension across the saw blade during the longitudinal movement. The fixture allows the saw blade angle to be fixed relative to the workpiece.

### BACKGROUND

### Field of the Disclosure

The disclosure relates generally to a fixture that is manually moved by a user to guide a saw blade cut line along a desired cut path on the workpiece surface. The fixture geometry is configured to maintain the saw blade cut line angle relative to a workpiece surface. The saw blade cut line results from the saw blade motion driven by a powered tool attached to the fixture. The disclosed methods and fixtures may be used for coping or scribing a molding to fit against the contours of an abutting member.

### Description of Related Art

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

In woodworking related to the installation of molding (also known as molding or coving) it is often necessary to cut a workpiece to match the contour of an existing piece at the corner formed by two adjacent walls. One technique for creating the cut matching the contour is known as coping or scribing. When coping a workpiece by hand, a user typically uses a coping saw (see, for example, FIG. 15) and uses her or his hands to do all of the following: (1) execute the saw motion to cut the workpiece, (2) maintain the desired cut angle relative to the surface of the workpiece, and (3) follow the cut path on the workpiece to create the contour required to mate to an adjacent piece—see, for example, coped edge of molding 142 in FIG. 14.

U.S. Pat. No. 4,095,635 describes a coping saw for manual coping of a workpiece. The described coping saw has a generally U-shaped frame with slots at the end for receiving a saw blade.

U.S. Pat. No. 5,027,518 describes a U-shaped frame removably mounted to a saw main frame to support an outer end of a coping saw blade having an inner end removably mounted to a reciprocally driven linkage connected to a battery-operated motor contained in a handle.

U.S. Pat. No. 6,282,793 describes a coping saw attachment for a handheld power jig saw which is capable of being quickly and easily attached to a standard handheld power jig saw. The coping saw attachment for a hand held power jig saw generally includes a substantially “c-shaped” coping saw blade support member which supports a standard coping saw blade, a handle which is removably attached on either side of the substantially “c-shaped” coping saw blade support member and a coping saw blade adapter which facilitates the attachment of a standard coping blade into a hand held power jig saw blade chuck. The outward end of the substantially “c-shaped” coping saw blade support member retains the outwardly extending end of the standard coping saw blade and the substantially “c-shaped” coping saw blade support member has sufficient flexibility to move and retain force on the standard coping saw blade as the hand held power jig saw moves the standard coping saw blade up and down in a substantially vertical orientation.

U.S. Pat. No. 6,152,009 describes an architectural millwork jig for the cutting of at least one cope in a strip of architectural millwork such as crown molding. The jig includes a base for stabilizing the millwork and further includes a table with a through opening positionable over the end face to be cut. A powered jig saw rides on the table about the opening, where the powered jig saw includes a foot for riding on the table and a blade reciprocating between two toes of the foot, and where the blade makes the cut in the end face of the millwork. The table is swingable about at least the x and y axes so as to provide a proper alignment for the surface of the table on which the foot of the powered jig saw rides. Swinging of the table about one axis permits one jig to be used for right hand and left hand copes and further permits the table to be adjusted to the exact angle of the right hand cope or to the exact angle of the left hand cope. Swinging about this one axis further permits the table to be swung into position to cope flat miters. Swinging of the table about another axis permits the table to be aligned relative to the slope of the bevel.

U.S. Pat. No. 6,422,117 describes a jig for holding a piece of crown molding and guiding a hand-held jigsaw at a particular angle to aid in coping the molding. The jig has a horizontal base plate and two vertical side fences. A guide plate is attached between the front ends of the fences and is spaced from the base plate by a gap. The guide plate is oriented as if rotated through two particular angles about two respective axes from a position normal to the fences and base plate. The resulting front surface of the guide plate guides a jigsaw in the coping process. An opening in the guide plate is aligned with the upper surface of the base plate and allows molding to be placed on the base plate with an end in the opening to interfere with the jigsaw blade at a desired coping angle. First, the molding is placed inverted against a miter saw fence, and an end of the molding is cut at a 45-degree angle. Next the molding is placed in the jig, with the cut end in the opening of the guide plate. A jig saw is placed on the front surface of the guide plate, and the operator manually guides the jigsaw to follow the contour of the front surface of the molding along the miter cut line. This produces a coped end for a clean 90-degree joint in crown molding.

### SUMMARY OF THE DISCLOSURE

Embodiments disclosed herein relate to fixtures, systems, and methods for cutting a workpiece, for example, to cope a piece of crown molding for installation in a corner. In some embodiments, the fixtures or systems comprise one or more receivers to secure a saw blade to a powered tool or to a fixture with the fixture adapted to position the saw blade at a fixed angle relative to a feature (e.g., base) of the fixture. In some embodiments, a saw blade receiver may be adapted to guide the saw blade along a longitudinal stroke. In some embodiments, a saw blade receiver may be adapted to maintain the saw blade under tension during at least a portion of a longitudinal stroke. In some embodiments, the methods relate to mounting of a saw blade in a receiver or driving the motion of a saw blade.

### BRIEF DESCRIPTION OF THE DRAWINGS

FIG. 1 is a perspective view of an exemplary fixture and a battery-powered jigsaw for performing a cut on a workpiece.

FIG. 2 is a side view of the exemplary fixture and jigsaw from FIG. 1.

FIG. 3 is a front view of the exemplary fixture and jigsaw from FIGS. 1 and 2.

FIG. 4 is a top view of the exemplary fixture and jigsaw from FIGS. 1, 2, and 3.

FIG. 5 is a zoom-in of the side view of the exemplary fixture and jigsaw from FIGS. 1 to 4.

FIG. 6 is a zoom-in of the front view of the exemplary fixture from FIGS. 1 to 4 with various components (e.g., the jigsaw) removed.

FIG. 7 is a zoom-in front view of the exemplary fixture from FIGS. 1 to 4 with various components removed.

FIGS. 8A, 8B, and 8C are perspective views of the jigsaw with adapter and the tool receiver from FIGS. 1 to 4 with the jigsaw and tool receiver in different orientations.

FIGS. 9A and 9B show a saw blade and an exemplary tool-end saw blade receiver.

FIG. 9C shows a spiral saw blade for use with a fixture.

FIG. 10 shows a jigsaw blade with an exemplary insert designed to couple to a jigsaw blade receiver on a jigsaw.

FIG. 11 shows an exemplary tool-end saw blade receiver installed on a jigsaw.

FIGS. 12A, 12B, and 12C show the components of an exemplary fixture-end saw blade receiver.

FIG. 13 shows components of an exemplary fixture-end saw blade receiver mounted to a fixture.

FIG. 14 shows a view of a first molding piece that has been coped to match to the profile of a second molding piece.

FIG. 15 shows a hand-held coping saw.

FIG. 16 illustrates the use of a fixture and jigsaw to cut a molding.

FIG. 17 shows an exemplary embodiment of a fixture with a jigsaw and saw blade attached.

FIG. 18 shows a zoom-in view of a fixture, a jigsaw, and an insert connected to a saw blade clamp.

FIG. 19 shows an exemplary fixture-end saw blade receiver.

FIG. 20 shows views of crown molding with three different spring angles mounted between a wall and a ceiling.

FIG. 21 shows coped crown molding inside corners for three different wall angle configurations.

FIGS. 22, 23, and 24 show top views of crown molding coped for use in an inside corner having a 90 deg, 120 deg, and 150 deg corner, respectively.

FIG. 25 shows the top view of a coped crown molding.

### DETAILED DESCRIPTION

The present description is made with reference to the accompanying drawings, in which various example embodiments are shown. However, many different example embodiments may be used, and thus the description should not be construed as limited to the example embodiments set forth herein. Rather, these example embodiments are provided so that this disclosure will be thorough and complete. Various modifications to the exemplary embodiments will be readily apparent to those skilled in the art, and the generic principles defined herein may be applied to other embodiments and applications without departing from the spirit and scope of the disclosure. Thus, this disclosure is not intended to be limited to the embodiments shown but is to be accorded the widest scope consistent with the principles and features disclosed herein.

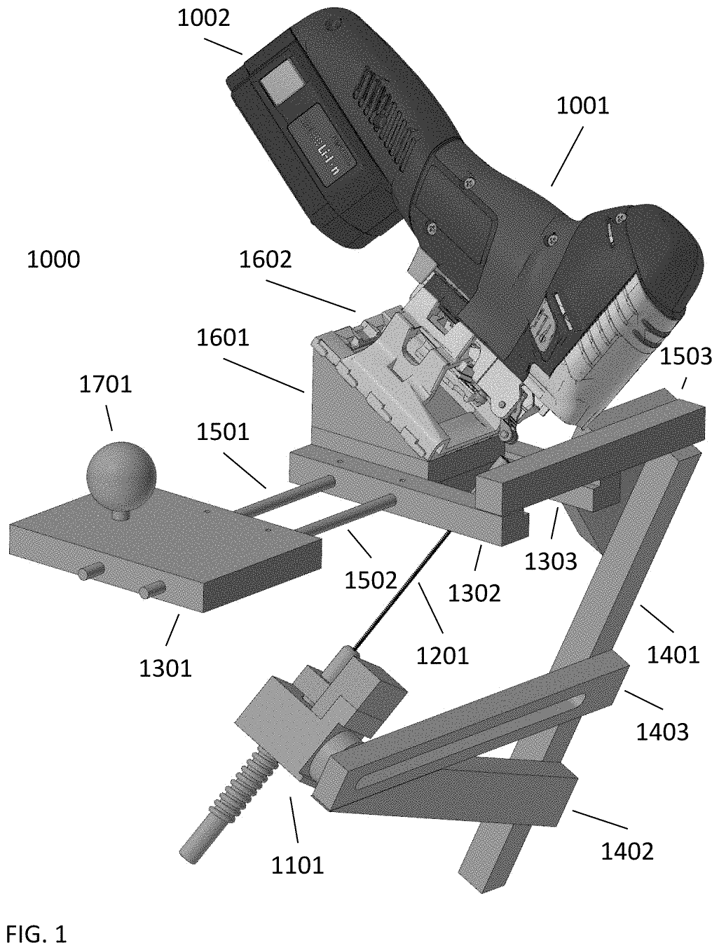

FIG. 1 shows a perspective view of an exemplary embodiment of a fixture 1000 for use in cutting a workpiece. FIG. 1 also shows a battery-powered jigsaw 1001 and a battery 1002 with the battery-powered jigsaw 1001 attached to the fixture 1000. The fixture 1000 includes a fixture base (e.g., comprising base members 1301, 1302, and 1303). During use, in some embodiments, at least a portion of the fixture base rests on the top surface of the workpiece during cutting. During use, in some embodiments, one or more base members may be wholly or partially off of the workpiece top surface as the fixture is moved during cutting of the workpiece. In some embodiments, the size of the fixture base footprint may be adjustable. For example, base member 1301 may be moved relative to base member 1302 along guides 1501 and 1502 to adjust the size of the fixture base footprint. In some embodiments, the workpiece may be secured to a worksurface (e.g., using a clamp) and the fixture base may be placed on the top surface of the workpiece to cut the workpiece. In some embodiments, a tool other than a jigsaw may be used to drive the motion of the saw blade. For example, the tool may be any powered tool that can drive the saw blade in a reciprocating motion (e.g., a tool based on a scroll saw, insulating-material saw (e.g., Festool ISC 240 EB-Basic)).

In some embodiments, one or more handles (e.g., handle 1701) may be provided on the fixture 1000 to secure or guide the fixture during use. In some embodiments, if a portion of the weight of the fixture or a portion of the weight of the jigsaw is unsupported by the fixture base or the surface of the workpiece, a force may be applied to portions of the fixture base or one or more handles to keep at least a portion of the fixture base positioned on the surface of the workpiece. In some embodiments, the tool used with the fixture may be powered via a power cord (e.g., corded jigsaw) instead of being powered by a battery (e.g., cordless jigsaw).

In some embodiments, fixture 1000 includes a tool receiver for mounting a tool to the fixture 1000. In some embodiments, as shown in FIG. 1, the tool receiver includes wedge 1601 and tool receiver 1602 for removably mounting a tool to the fixture 1000. For example, a tool may have an adapter designed to removably couple to a tool receiver on the fixture for mounting the tool on the fixture—see, for example, coupling of Festool Jigsaw CARVEX PS 420 with Festool Angle Base WT-PS 420 or Guide Rail Base ADT-PS 420.

The fixture 1000 includes a fixture arm (e.g., comprising arm members 1401, 1402, and 1403). In some embodiments, the fixture arm may be connected to at least a portion of the fixture base via a connecting element (e.g., element 1503). In some embodiments, a fixture-end saw blade receiver 1101 may be mounted to the fixture arm (e.g., arm member 1403 as illustrated in FIG. 1). A saw blade 1201 may be mounted between the jigsaw 1001 and the fixture-end saw blade receiver 1101. In some embodiments, a first end of the saw blade 1201 may be connected to a tool-end saw blade receiver coupled to the jigsaw 1001. In some embodiments, a second end of the saw blade 1201 may be connected to the fixture-end saw blade receiver 1101. In some embodiments, the fixture includes a frame that comprises one or more of the fixture base, fixture arm, or other connecting elements (e.g., element 1501, 1502, or 1503).

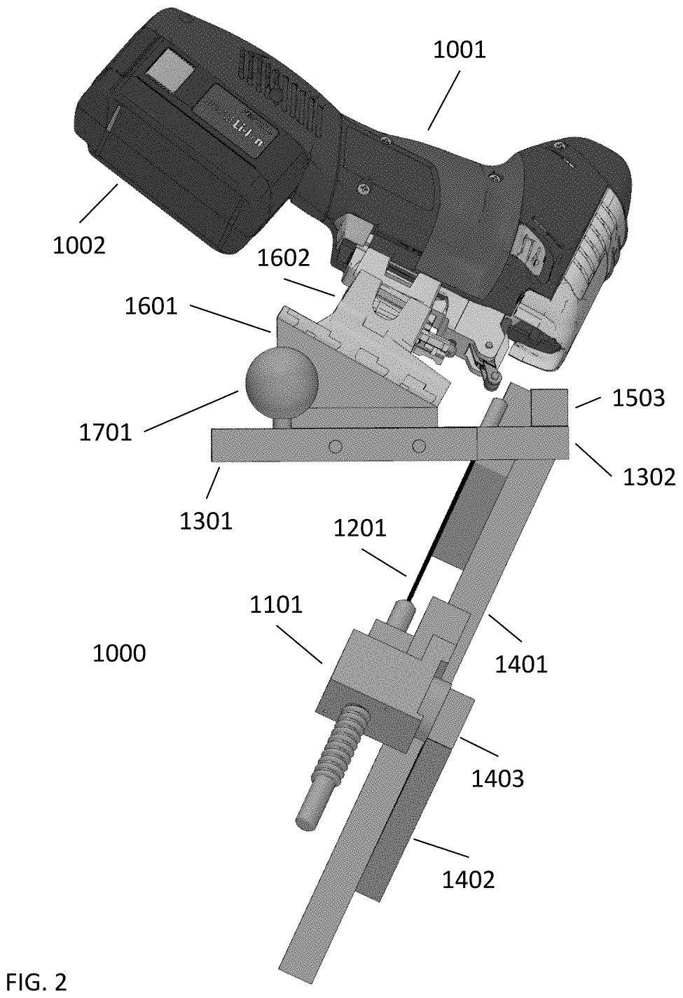

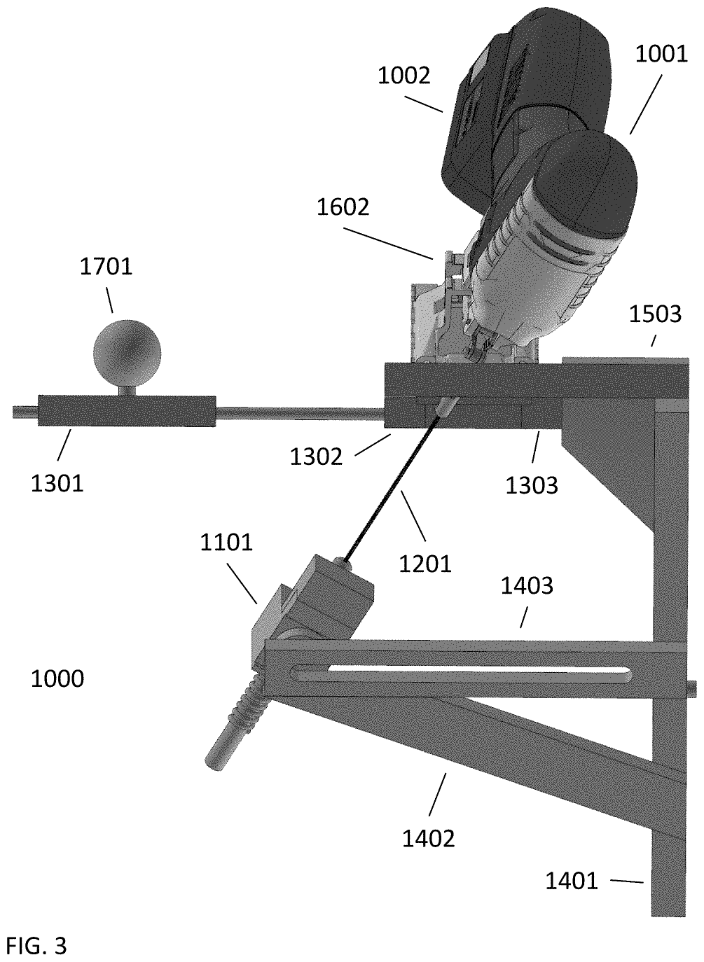

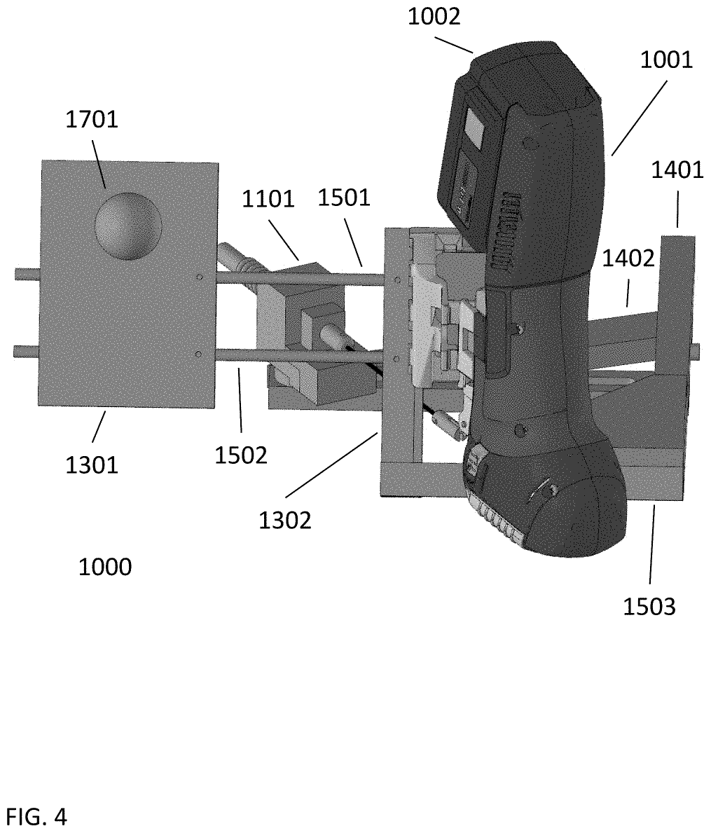

FIGS. 2 to 4 show different views of the exemplary fixture from FIG. 1. FIG. 2 shows a side view of the fixture 1000 and jigsaw 1001. The view in FIG. 2 shows the orientation of the fixture arm relative to the fixture base along a first direction. FIG. 3 shows a front view of the fixture 1000 and jigsaw 1001. The view in FIG. 3 shows the orientation of the fixture arm relative to the fixture base along a second direction. FIG. 4 shows the top view of the fixture 1000 and jigsaw 1001. In some embodiments, the arm members, guides, and base members may be designed to be rearranged so that the fixture may be configured for right-handed use (e.g., jig saw 1001 in right hand and handle 1701 in left hand) or left-handed use (e.g., jig saw 1001 in left hand and handle 1701 in right hand) while maintaining the capability of fixing angle 1 and angle 2 for the saw blade motion.

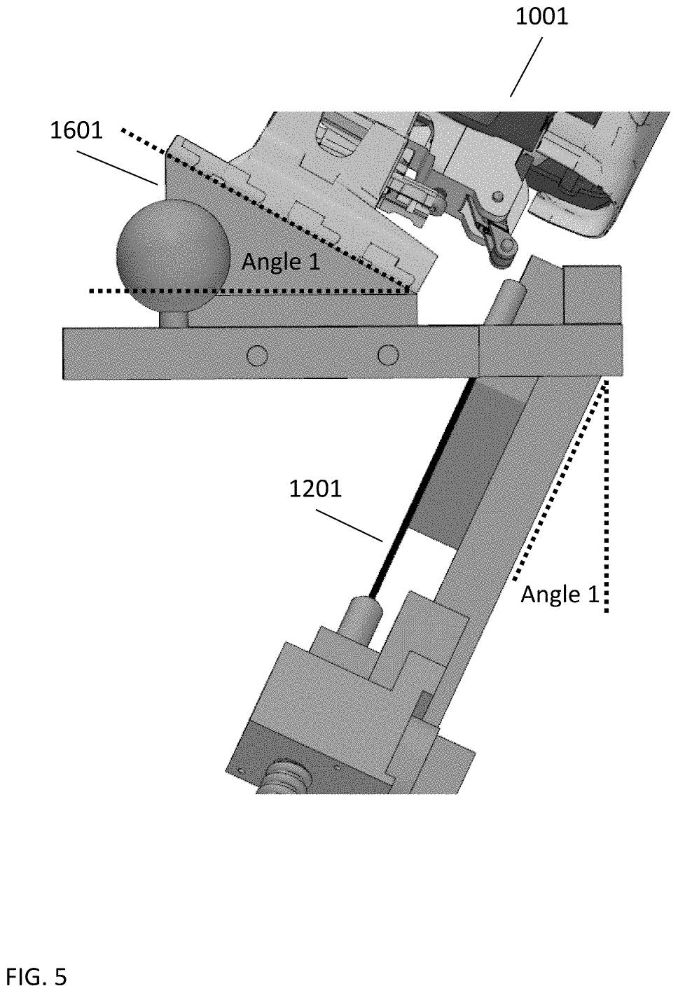

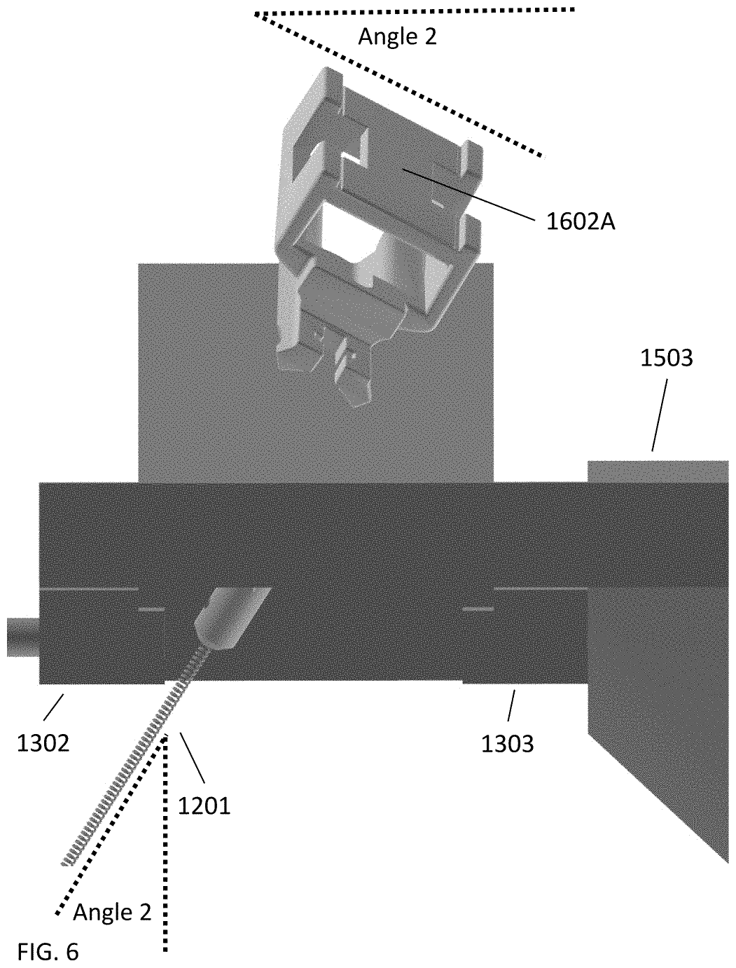

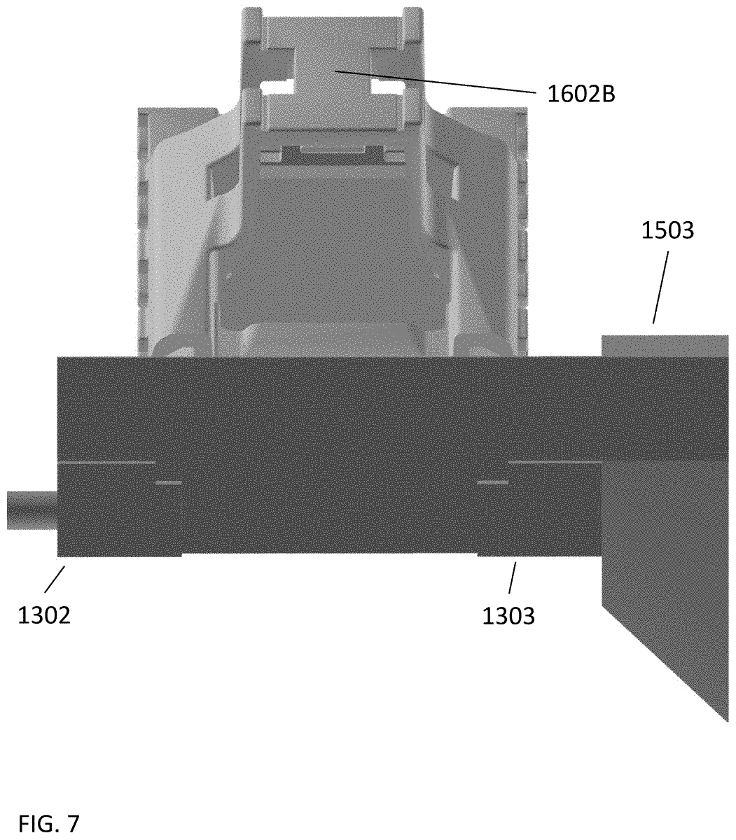

In some embodiments, as shown in the zoomed-in side view of FIG. 5, the angle of wedge 1601 of the tool receiver orients the position of the jigsaw (and, hence, also the orientation of the saw blade) relative to the fixture base along the first direction, identified as angle 1 in FIG. 5. In some embodiments, wedge 1601 may be omitted such that angle 1 is zero. In some embodiments, as shown in the zoomed-in front view of FIG. 6, the angle of tool receiver 1602A (see corresponding tool receiver 1602 in FIGS. 1-3) orients the position of the jigsaw (and, hence, also the orientation of the saw blade) relative to the base along the second direction, identified as angle 2 in FIG. 6. In some embodiments, as shown in the zoomed-in front view of FIG. 7, the angle of the tool receiver 1602B orients the position of the jigsaw relative to the base such than angle 2 is zero. In some embodiments, one or both of angle 1 and angle 2 may be adjustable (for example, using a mechanism similar to what is used in angle-adjustable Festool Angle Base WT-PS 420) to permit coping for molding used in different geometries, e.g., different spring angles, different angles between adjacent walls (see Appendix, below).

Installation of molding typically requires customized coping to account for one or more of: different spring angles, different wall corner angles, different design/pattern/topography of molding, installation of molding at inside or outside corners, and coping of one or more moldings for installation at a given corner. In some embodiments, the fixture may be configured to maintain a cut angle orientation for one or more of the above-mentioned molding installation scenarios. The ability to maintain a given cut angle is important to: (1) ensure that the cut profile of the coped molding matches the profile of the adjacent molding, and (2) ensure that the coped molding does not mechanically interfere with the profile of the adjacent molding when the coped joint is formed. The issue of improper mechanical interference is addressed based on the proper undercutting of the coped molding based on the cut angle.

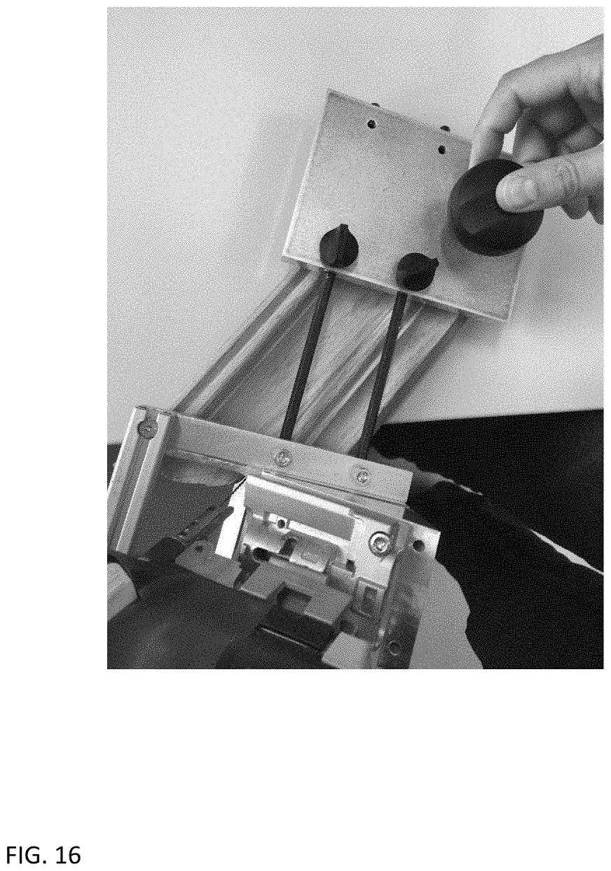

When coping a molding using the fixture with a powered jigsaw driving the saw blade motion, a user may guide the fixture (e.g., using handle 1701) to follow the cut path (e.g., marked) on the surface of the molding to create the contour required to match the profile of an adjacent piece, see, for example, FIG. 14. As shown in FIG. 16, with at least a portion of the fixture base resting on the molding surface, a portion of the weight of the fixture and jigsaw may be supported by the molding. The powered jigsaw executes the saw motion to cut the molding using the saw blade. The fixture maintains the desired cut angle relative to the surface of the molding. This workflow for coping a molding helps the user perform the coping task with greatly reduced effort compared to manually coping using a traditional coping saw, see, for example, FIG. 15.

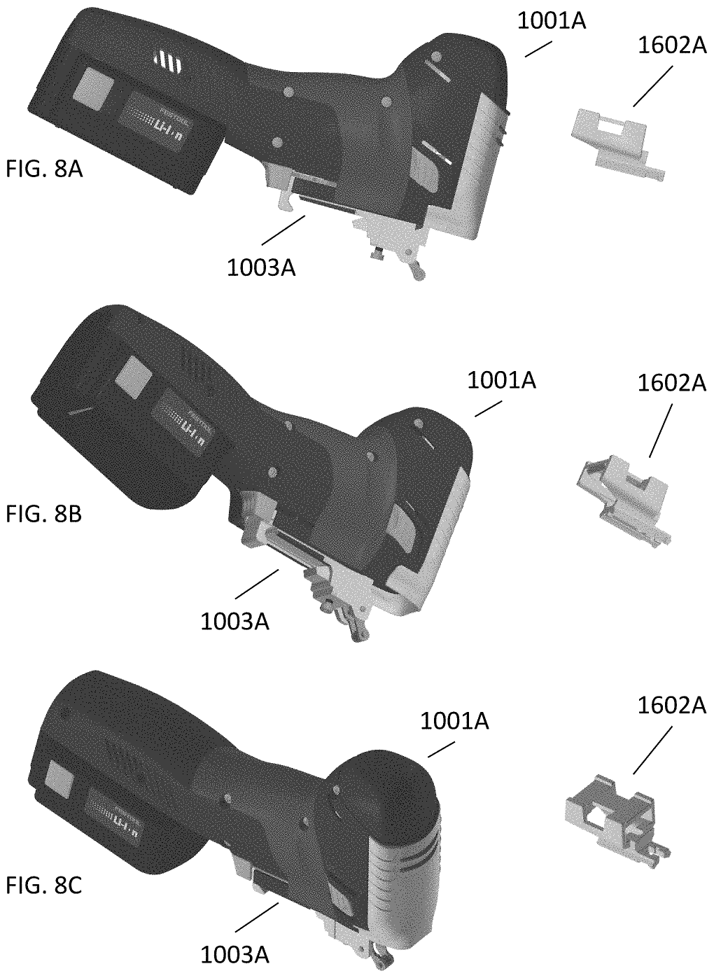

FIGS. 8A, 8B, and 8C shows different views of jigsaw 1001A and tool receiver 1602A with the same relative orientation. Jigsaw 1001A includes an adapter 1003A mounted underneath. The adapter 1003A of jigsaw 1001A is configured to removably couple to the tool receiver 1602A. The tool receiver 1602A on fixture 1000 allows different tools to be mounted on the fixture 1000. The tool receiver 1602A on fixture 1000 allows a tool with an adapter 1003A mounted on the fixture 1000 to be used for other tasks once the tool is decoupled from the fixture 1000.

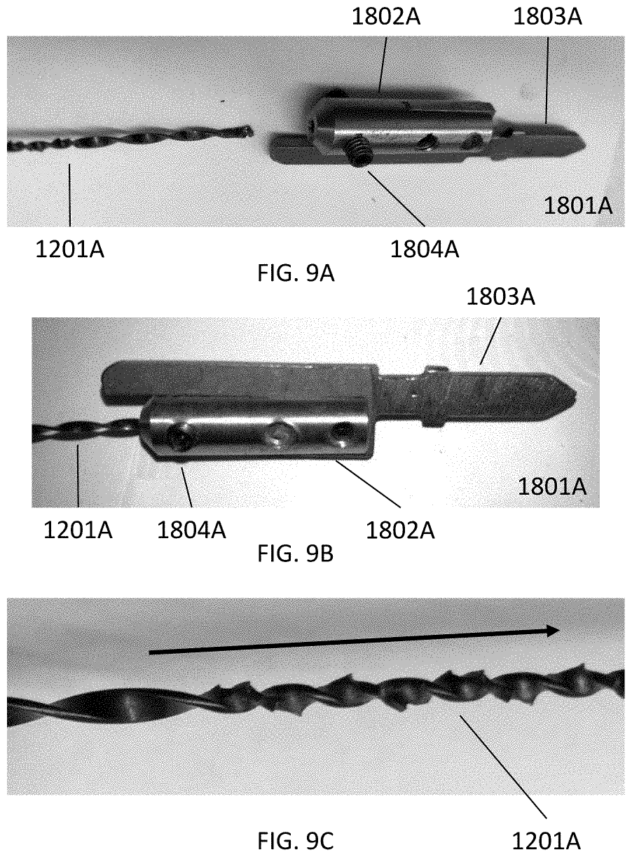

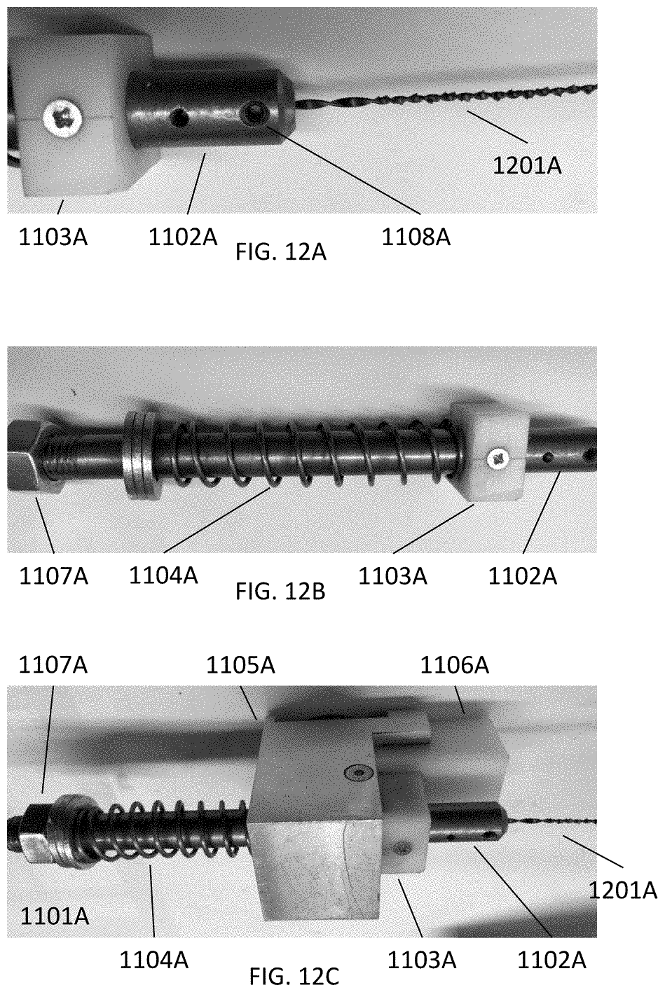

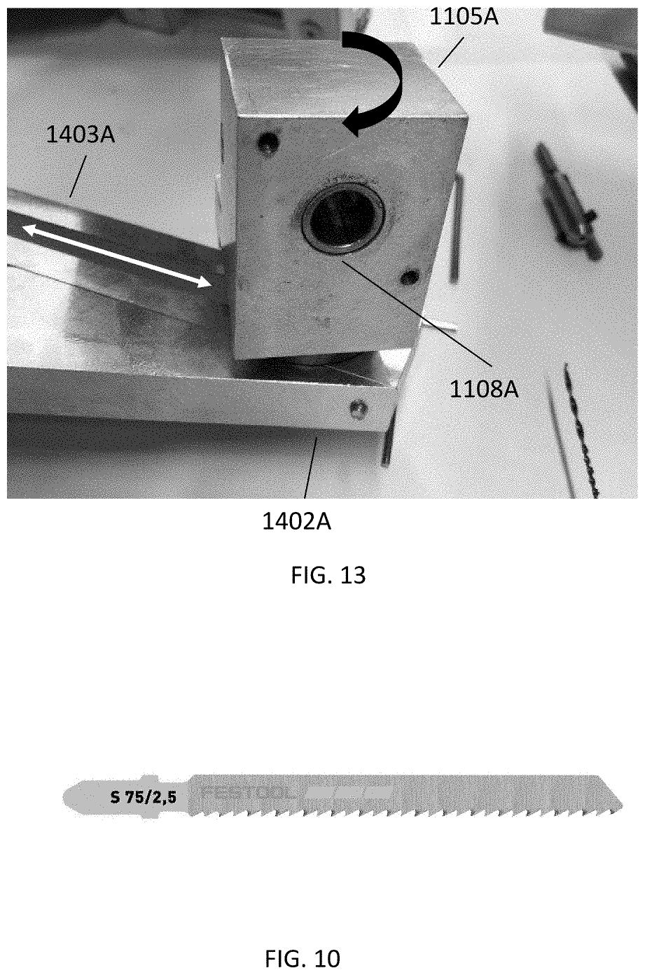

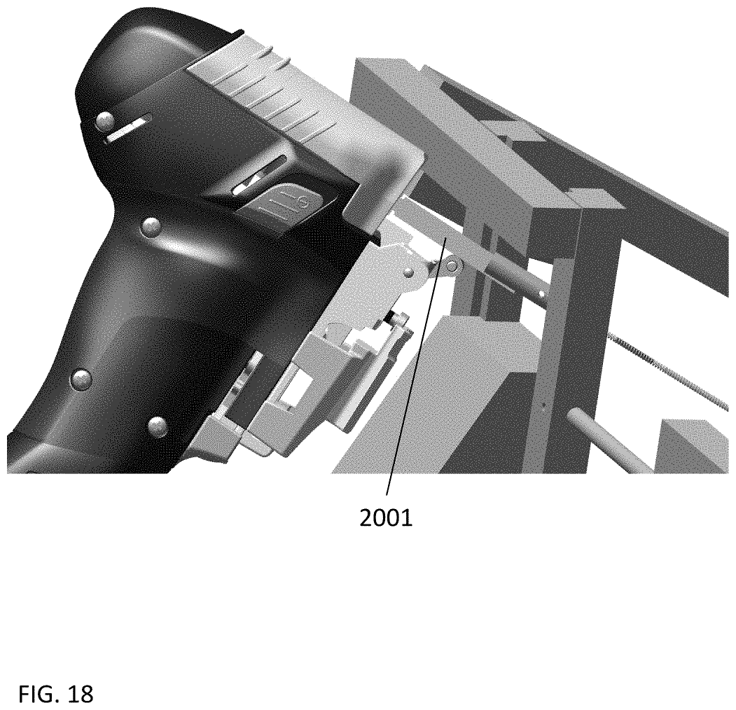

FIG. 9A shows an exemplary tool-end saw blade receiver 1801A for coupling a first end of the saw blade 1201A to a jigsaw. The tool-end saw blade receiver 1801A includes an insert 1803A that couples to a jigsaw blade receiver on the jigsaw. In some embodiments, the insert 1803A matches the insert design of a jigsaw blade as shown in FIG. 10. The width of the jigsaw blade shown in FIG. 10 is approximately 6-10 mm (approximately ¼″ to ⅜″). As shown in FIG. 9A, tool-end saw blade receiver 1801A includes a saw blade clamp 1802A for securing the first end of saw blade 1201A using one or more fasteners (e.g., set screw 1804A). In some embodiments, the saw blade clamp 1802A is coupled to the insert 1803A using one or more fasteners, e.g., screws. In some embodiments, the saw blade may be a spiral saw blade 1201A as shown in FIG. 9A. FIG. 9B shows the spiral saw blade 1201A clamped to the saw blade clamp 1802A of the tool-end saw blade receiver 1801A. In some embodiments, the tool-end saw blade receiver may be a single piece combining the insert and the saw blade clamp. In some embodiments, the tool-end saw blade receiver may comprise two or more components adapted to mount a saw blade to a receiver on the tool. In some embodiments, at least one end of the saw blade may have a through hole for securing the saw blade end to a respective saw blade receiver. FIG. 18 shows the saw blade 2001 omitted in the CAD views shown in FIGS. 1-5.

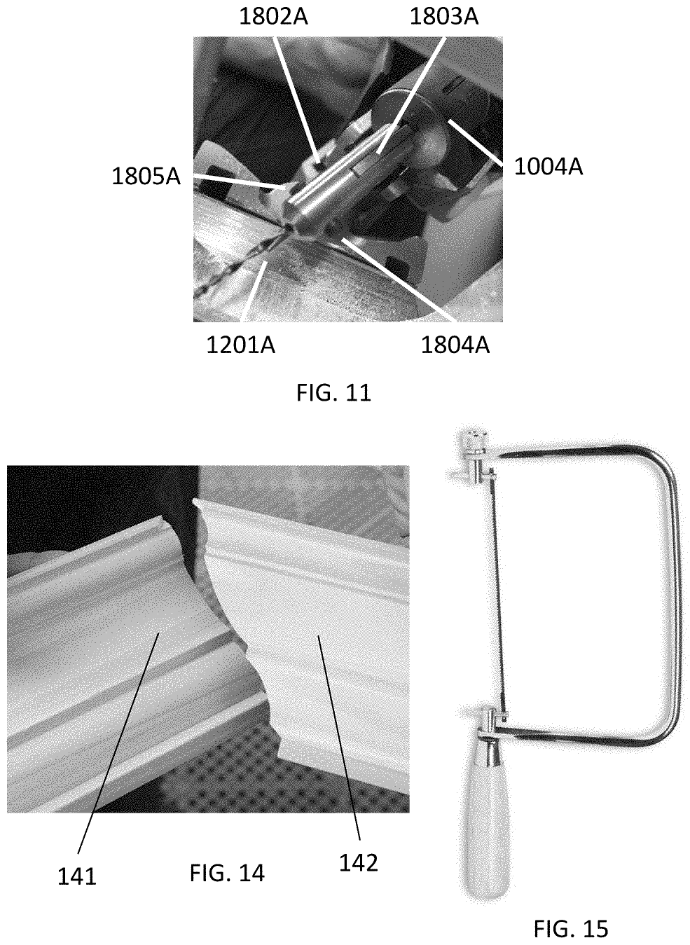

FIG. 11 shows tool-end saw blade receiver 1801A, with saw blade clamp 1802A and insert 1803A, connected to jigsaw blade receiver 1004A. Set screws 1804A and 1805A secure the saw blade 1201A to the saw blade clamp 1802A.

FIG. 9C shows a close up of spiral saw blade 1201A. In some embodiments, the teeth of the spiral saw blade are oriented to point towards the jigsaw, e.g., with the jigsaw on the right for the orientation of spiral saw blade 1201A teeth in FIG. 9C. This orientation permits the spiral saw blade to engage the workpiece material more effectively as the spiral saw blade is driven longitudinally towards the jigsaw (indicated by arrow) during the jigsaw cut stroke. The motion of the saw blade stroke may be substantially longitudinal such that the motion of the saw blade is bounded within a cylindrical region having a diameter which is: (1) less than 10, 5, 3, 2, 1.5, 1.3, or 1.1 times the widest portion of the saw blade, or (2) less than 10 mm, 8 mm, 6 mm, 4 mm, 2 mm, or 1 mm. The use of a spiral saw permits omnidirectional cutting compared to cutting along a direction fixed by the plane of the saw blade in the case of the use of a saw blade similar to the jigsaw blade as shown in FIG. 10. In some embodiments, the spiral saw blade 1201A is between 100 mm and 150 mm. In some embodiments, the spiral saw blade 1201A is between 0.4 mm and 0.7 mm in diameter (at the widest point). In some embodiments, the length of the spiral saw blade 1201A used for cutting may be based at least in part on the diameter of the spiral saw blade 1201A. In some embodiments, the tension applied to the spiral saw blade 1201A during cutting (see below) may be based at least in part on the diameter of the spiral saw blade 1201A.

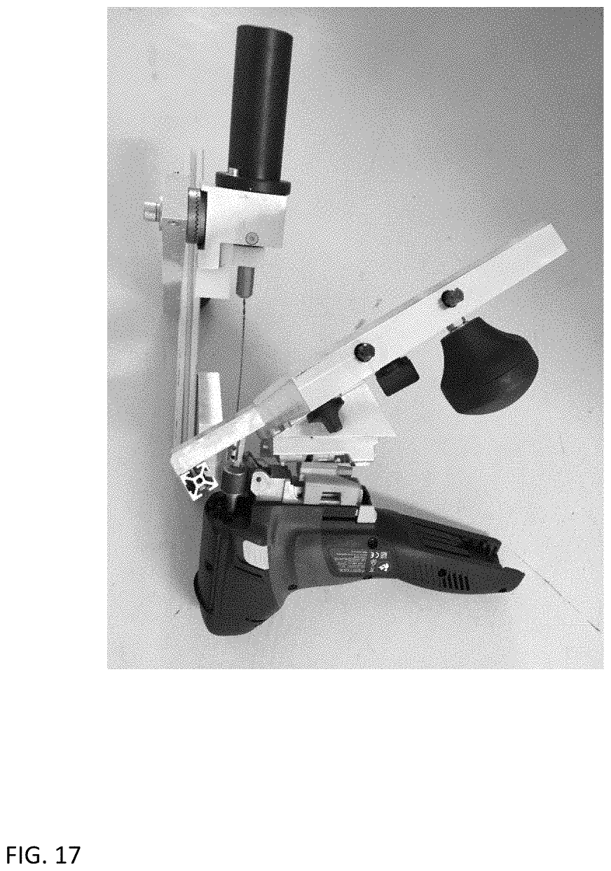

FIGS. 12A, 12B, and 12C show an exemplary fixture-end saw blade receiver 1101A (see corresponding fixture-end saw blade receiver 1101 in FIGS. 1-4) for connecting a second end of the saw blade 1201A. As shown in FIG. 12A, the fixture-end saw blade receiver 1101A includes a stroke rod 1102A with a stroke stop 1103A. In some embodiments, the stroke stop may be used to prevent the stroke rod from slipping out (e.g., due to tension from the spring) through fixture mount 1105A when the saw blade is removed. A second end of saw blade 1201A is secured to the stroke rod 1102A using one or more fasteners (e.g., set screw 1108A). As shown in FIG. 12B, the fixture-end saw blade receiver includes a spring 1104A and a spring stop 1107A. FIG. 12C shows the assembled fixture-end saw blade receiver 1101A including fixture mount 1105A and stroke slide 1106A. The stroke slide 1106A guides the stroke stop 1103A during the saw blade stroke (right to left and back in FIG. 12C). In some embodiments, the fixture-end saw blade receiver may be partially covered (as shown in FIG. 17) to protect the user from moving components (e.g., stroke rod 1102A, spring 1104A, spring stop 1107A) during use of the fixture and the tool for cutting.

In some embodiments, the spring 1104A is kept under compression during a portion of the saw blade stroke to apply a tension on the saw blade. In some embodiments, the spring 1104A is configured to apply more than 5 N, 10 N, or 20 N of tension on the saw blade during the saw blade stroke. In some embodiments, the spring 1104A is configured to apply less than 100 N, 80 N, or 60 N of tension on the saw blade during the saw blade stroke. The tension in the saw blade during the saw blade stroke may range from a low selected from (5 N, 10 N, or 20 N) to a high selected from (60 N, 80 N, or 100 N). In some embodiments, the tension in the saw blade may vary during the saw blade stroke—varying, for example, from 50 N down to 30 N as the saw blade moves away from the jigsaw and increasing from 30 N to 50 N as the saw blade moves towards the jigsaw. In some embodiments, the saw blade stroke may comprise a motion of 25 mm away from the jigsaw and a motion of 25 mm towards the jigsaw—with the saw blade stroke traversing a total of 50 mm in one full stroke. In some embodiments, in this example, the saw blade may be under tension for 25 mm (50%), 35 mm (70%), 45 mm (90%), or 47.5 mm (95%) of the total 50 mm saw blade stroke.

In order to keep tension on the saw blade during the saw blade stroke, in some embodiments, spring 1104A may be compressed when the saw blade is installed between the fixture-end saw blade receiver and the tool (e.g., jigsaw). In some embodiments, the saw blade may be kept under tension during the saw blade stroke using a mechanism other than a spring element (e.g., spring, leaf spring, flexure, damper with compressed gas or liquid). For example, in some embodiments, the fixture-end saw blade receiver 1101 may be driven in phase with the jigsaw 1001 motion (e.g., to maintain tension in the saw blade). In some embodiments, in addition to a spring element or instead of a spring element, a mechanical system such as a cantilever lever with an eccentric cam may be used to apply a portion of the tension (with a spring element, if present, also applying tension) during the saw blade stroke or to facilitate changing of the saw blade.

FIG. 13 shows the fixture mount 1105A of the fixture-end saw blade receiver 1101A mounted to arm member 1403A of a fixture. An arm member 1402A of the fixture is attached to the arm member 1403A. In some embodiments, the stroke rod opening in 1105A is lined with a stroke rod bearing 1108A as shown in FIG. 13. In some embodiments, the position of fixture-end saw blade receiver 1101A may be adjusted along a slot (indicated by the arrow in FIG. 13) in arm member 1403A. The position of fixture-end saw blade receiver 1101A may be adjusted along the slot and the orientation of the stroke rod opening in fixture mount 1105A may be rotated at a given position (as indicated by the black curved arrow) to align the fixture-end saw blade receiver 1101A to the tool blade adapter (e.g., jigsaw blade receiver 1004A in FIG. 11) based on angle 1 or angle 2.

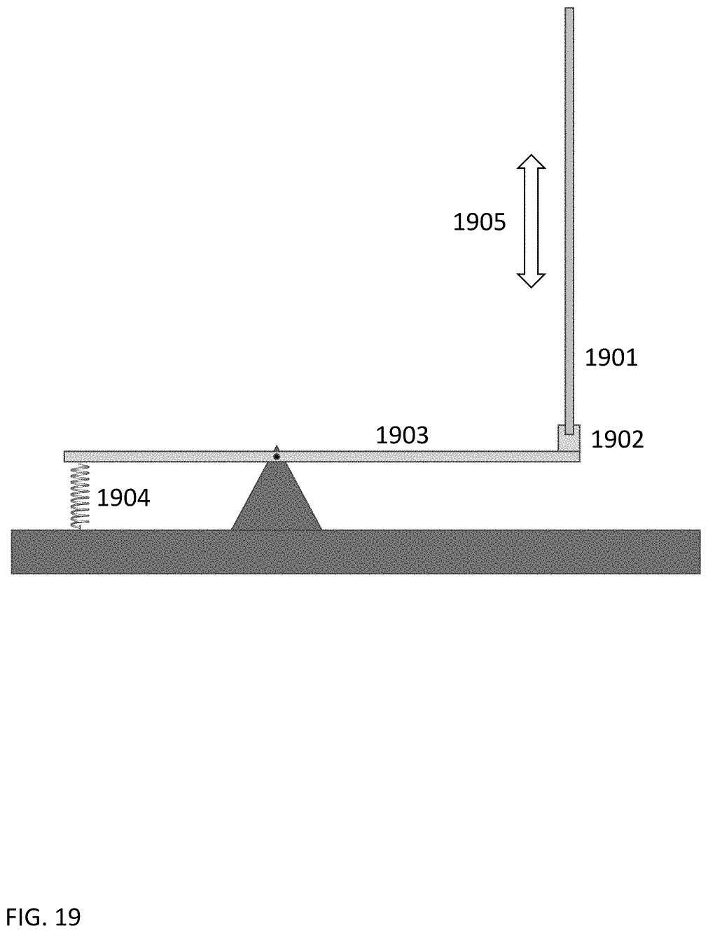

FIG. 19 shows an exemplary fixture-end saw blade receiver with saw blade 1901 coupled to a saw blade clamp 1902. In some embodiments, the saw blade clamp 1902 is coupled to a hinged lever 1903 with the hinged lever coupled to one or more of a spring element (e.g., spring 1904), an eccentric cam, or the like. In some embodiments, one or more of the spring element, the eccentric cam, or the like may be configured to apply a tension on the saw blade 1901 during at least a portion of the saw blade longitudinal stroke movement indicated by arrow 1905. In some embodiments, a lever may be fixed at one end and apply a tension to a saw blade while the other end of the lever is in a deflected state. Any suitable fixture-end saw blade receiver, including the fixture-end saw blade receiver illustrated in FIG. 19 and described above, may be used with any of the embodiments of the fixtures, systems, and methods herein.

Although the disclosure may not expressly disclose that some embodiments or features described herein may be combined with other embodiments or features described herein, this disclosure should be read to describe any such combinations that would be practicable by one of ordinary skill in the art. Unless otherwise indicated herein, the term “include” shall mean “include, without limitation,” and the term “or” shall mean non-exclusive “or” in the manner of “and/or.”

Those skilled in the art will recognize that, in some embodiments, some of the operations described herein may be performed by human implementation, or through a combination of automated and manual means. When an operation is not fully automated, appropriate components of embodiments of the disclosure may, for example, receive the results of human performance of the operations rather than generate results through its own operational capabilities.

All references, articles, publications, patents, patent publications, and patent applications cited herein are incorporated by reference in their entireties for all purposes to the extent they are not inconsistent with embodiments of the disclosure expressly described herein. However, mention of any reference, article, publication, patent, patent publication, and patent application cited herein is not, and should not be taken as an acknowledgment or any form of suggestion that they constitute valid prior art or form part of the common general knowledge in any country in the world, or that they are disclose essential matter.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

Appendix

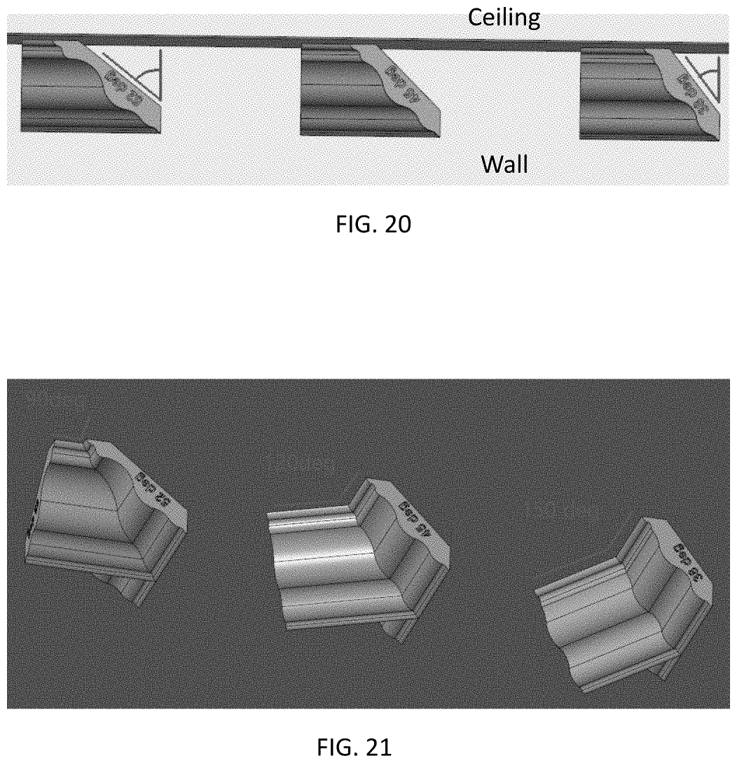

FIG. 20 shows crown molding with 3 different spring angles: 52 deg, 45 deg, and 38 deg. FIG. 21 shows coped crown molding inside corners (with different spring angles) with two walls forming 90 deg, 120 deg, and 150 deg corners. Note that in each of the coping unions in FIG. 21, the right side crown molding is not coped; the left side crown molding is coped to match the topography of the right side crown molding when fixtured to the right side wall. This type of coping union is also illustrated in FIG. 14 (see above). In some embodiments, both sides of the molding may be coped to match at a corner.

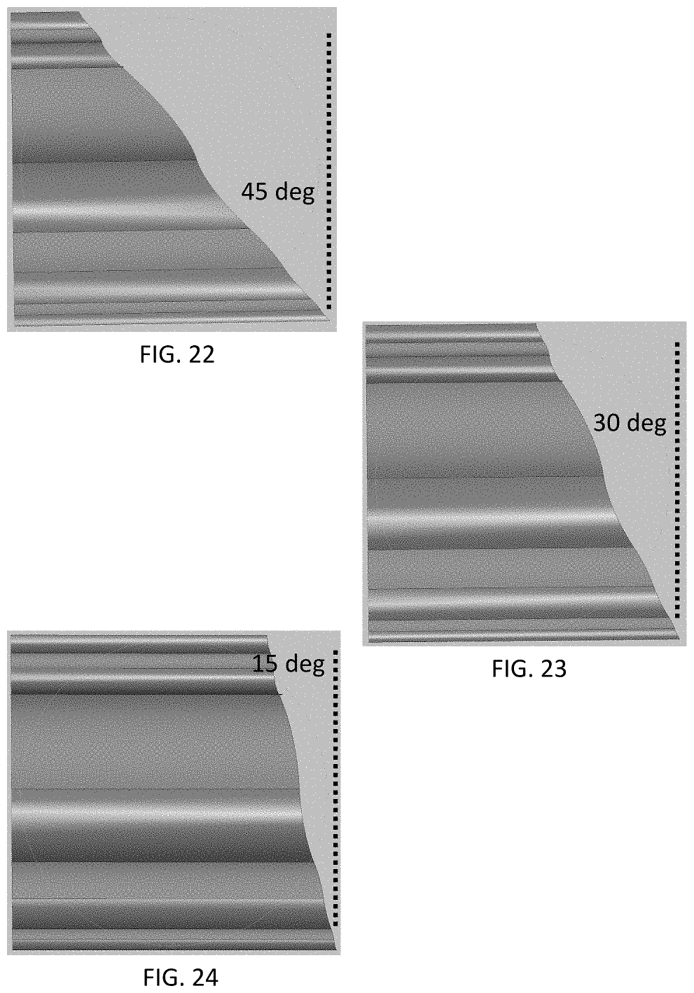

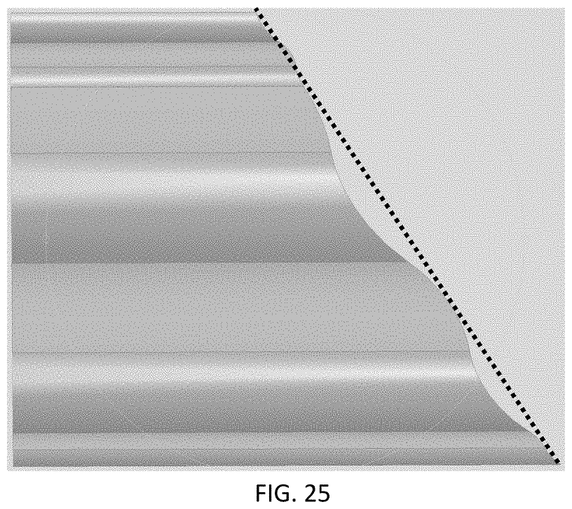

FIGS. 22, 23, and 24 each show a coped crown molding with a 52 deg spring angle that is coped for use in an inside corner having a 90 deg, 120 deg, and 150 deg corner, respectively. Note that the cut angle for the molding (approximately 45 deg, approximately 30 deg, and approximately 15 deg for FIGS. 22, 23, and 24, respectively) is approximately 90 deg minus half of the wall corner angle—this angle is referred to as the Primary Cut Angle. In some embodiments, for coping a crown molding for use in corner with a given angle, angle 1 (see FIG. 5 and description above) of the fixture is set to the Primary Cut Angle, and angle 2 (see FIG. 6 and description above) of the fixture is set to 90 deg minus the Primary

Cut Angle. The table below summarizes the relationship between the wall corner angle, Primary Cut Angle, angle 1, and angle 2.

| Wall Corner Angle | Primary Cut Angle | Angle 1 | Angle 2 |
|---|---|---|---|
| 90 deg | 45 deg | 45 deg | 45 deg |
| 120 deg | 30 deg | 30 deg | 60 deg |
| 150 deg | 15 deg | 15 deg | 75 deg |

FIG. 25 shows the departure of the cut line from a straight line reference (dashed black line; given approximately by the Primary Cut Angle) to meet the “crests” and “troughs” of the crown molding to which the coped crown molding has to match. Once angle 1 and angle 2 are fixed for the cut, the user moves the fixture in the direction of the straight line reference while moving the saw blade to create the cut line that matches the other crown molding piece (e.g., as illustrated in FIG. 16).

1. A fixture comprising:
a frame;
a fixture-end saw blade receiver adapted to couple to the frame, wherein the fixture-end saw blade receiver comprises a stroke rod, the stroke rod is adapted to removably couple to a first end of a saw blade, and the stroke rod is adapted to guide the saw blade through a longitudinal stroke movement; and
a tool receiver adapted to couple to the frame, wherein the tool receiver is adapted to couple a powered tool to the frame, the powered tool is adapted to couple to a tool-end saw blade receiver, the tool-end saw blade receiver is adapted to removably couple to a second end of the saw blade, and the powered tool is adapted to drive the saw blade and the stroke rod through the longitudinal stroke movement.

2. The fixture of claim 1, wherein the fixture-end saw blade receiver comprises a spring element, and the spring element is adapted to apply a tension on the saw blade during at least a portion of the longitudinal stroke movement.

3. The fixture of claim 1, wherein the powered tool is a jigsaw.

4. The fixture of claim 1, wherein the powered tool is adapted to removably couple to the frame.

5. The fixture of claim 1, wherein the saw blade is adapted to permit omnidirectional cutting.

6. The fixture of claim 5, wherein the saw blade is a spiral saw blade.

7. The fixture of claim 1, wherein the frame comprises a base, a longitudinal axis of the saw blade is rotated by a first angle relative to a normal direction defined by the base, and the first angle is based at least in part upon the orientation of the fixture-end saw blade receiver and the tool-end saw blade receiver relative to the base.

8. The fixture of claims 1, wherein the longitudinal stroke movement is greater than 2 mm, 5 mm, 8 mm, or 10 mm in one direction.

9. The fixture of claim 2, wherein the tension is above 5 N, 10 N, or 20 N.

10. The fixture of claim 2, wherein the tension is below 60 N, 80 N, or 100 N.

11. The fixture of claim 2, wherein the tension varies during the longitudinal stroke movement, and the spring element is adapted to apply the tension during more than 50%, 70%, 90%, or 95% of the longitudinal stroke movement.

12. The fixture of claim 6, wherein the teeth of the spiral saw blade point towards the powered tool.

13. A system for performing a cutting task on a workpiece, the system comprising:
a frame;
a fixture-end saw blade receiver, wherein the fixture-end saw blade receiver is adapted to couple to the frame, the fixture-end saw blade receiver comprises a stroke rod, the stroke rod is adapted to removably couple to a first end of a saw blade, and the stroke rod is adapted to guide the saw blade through a longitudinal stroke movement;
a powered tool, wherein the powered tool is adapted to couple to the frame; and
a tool-end saw blade receiver, wherein the tool-end saw blade receiver is adapted to removably couple to a second end of the saw blade, the tool-end saw blade receiver is adapted to couple to the powered tool, and the powered tool is adapted to drive the saw blade and the stroke rod through the longitudinal stroke movement.

14-15. (canceled)

16. A method of performing a cutting task on a workpiece, the method comprising:
driving a saw blade along a first path using a powered tool, wherein the first path is along a first portion of a longitudinal stroke movement, driving the saw blade along the first path moves the saw blade longitudinally away from the powered tool, and the powered tool is coupled to a first end of the saw blade;
in response to the movement of the saw blade along the first path, moving a stroke rod in the same direction as the motion of the saw blade along the first path, wherein the stroke rod is coupled to a second end of the saw blade;
driving the saw blade along a second path using the powered tool, wherein the second path is along a second portion of the longitudinal stroke movement, and driving the saw blade along the second path moves the saw blade longitudinally towards the powered tool; and
in response to the movement of the saw blade along the second path, moving the stroke rod in the same direction as the motion of the saw blade along the second path.

17-19. (canceled)

20. The method of claim 16, wherein the saw blade is a spiral saw blade, and the teeth of the spiral saw blade point towards the powered tool.

21. The method of claim 16, in response to the movement of the stroke rod in the same direction as the motion of the saw blade along the second path, increasing tension in the saw blade using a spring element.

22. The method of claims 16, in response to the movement of the stroke rod in the same direction as the motion of the saw blade along the first path, decreasing tension in the saw blade using a spring element.

23. The method of claim 21, wherein the tension is above 5 N, 10 N, or 20 N, the tension is below 60 N, 80 N, or 100 N, the tension in the saw blade varies during the longitudinal stroke movement, and the spring element is adapted to apply the tension during more than 50%, 70%, 90%, or 95% of the longitudinal stroke movement.

24-32. (canceled)

33. The system of claims 13, wherein the fixture-end saw blade receiver comprises a spring element, and the spring element is adapted to apply a tension on the saw blade during at least a portion of the longitudinal stroke movement.

34-35. (canceled)

36. The system of claim 35, wherein the tension varies during the longitudinal stroke movement, and the spring element is adapted to apply the tension during more than 50%, 70%, 90%, or 95% of the longitudinal stroke movement.

37-41. (canceled)
